(19) United States
(12) Patent Application Publication
(10) Pub. No.: US 2006/0038722 A1
(43) Pub. Date: Feb. 23, 2006

(54) Planar inverted-F antenna

(76) Inventors: Kuo-Hua Tseng, Kaohsiung Hsien (TW); Kuan-Hsing Li, Taichung City (TW); Hui-Chung Lee, Taichung City (TW); Chuei-Tang Wang, Taichung City (TW)

Correspondence Address: DLA PIPER RUDNICK GRAY CARY US, LLP, 2000 UNIVERSITY AVENUE, E. PALO ALTO, CA, 94303-2248, US

(21) Appl. No.: 10/923,405

(22) Filed: Aug. 20, 2004

(51) Int. Cl. H01Q 1/38

(52) U.S. Cl. 343/700 MS; 343/895

(57) ABSTRACT

A planar inverted-F antenna includes a ground element, a shorting element, a radiating element, and a feeding element. The shorting element extends upwardly from the ground element. The radiating element is disposed above the ground element, and extends transversely from the shorting element. The radiating element includes a meandering strip and a flat plate. The meandering strip has opposite first and second ends. The first end of the meandering strip is coupled to the shorting element. The flat plate has a connecting side that is connected to the second end of the meandering strip and that has a length different from that of the second end of the meandering strip. The feeding element has a first end that is connected to the radiating element, and a second end that extends through and that is free from electrical contact with the ground element.

### BACKGROUND OF THE INVENTION

1. Field of the Invention

The invention relates to an antenna, more particularly to a planar inverted-F antenna.

2. Description of the Related Art

A conventional planar inverted-F antenna 1, as shown in FIG. 1, includes a ground element 11, a shorting element 12, a radiating element 13, and a feeding element 14. The shorting element 12 extends upwardly from the ground element 11. The radiating element 13 is disposed above the ground element 11, and extends transversely from the shorting element 12, and includes a flat plate 131. The feeding element 14 has opposite first and second ends. The first end of the feeding element 14 is coupled to the flat plate 131 of the radiating element 13. The second end of the feeding element 14 extends through and is free from electrical contact with the ground element 11, and is coupled to a transceiver (not shown).

In operation, a radio signal, which is sent to the transceiver, is fed to the conventional planar inverted-F antenna 1 through the feeding element 11. The fed radio signal is resonated by the conventional planar inverted-F antenna 1 and is radiated externally from the same.

Although the conventional planar inverted-F antenna 1 achieves its intended purpose, since it resonates with the radio signal at a particular frequency dependent upon the size of the flat plate 131 of the radiating element 13, the flat plate 131 of the radiating element 13 of the conventional planar inverted-F antenna 1 may be unacceptably large with certain applications.

### SUMMARY OF THE INVENTION

Therefore, the object of the present invention is to further reduce the size of a planar inverted-F antenna so as to overcome the aforesaid drawback of the prior art.

According to the present invention, a planar inverted-F antenna comprises a conductive ground element, a conductive shorting element, a conductive radiating element, and a feeding element. The shorting element extends upwardly from the ground element. The radiating element is disposed above the ground element, extends transversely from the shorting element, and includes a meandering strip and a flat plate. The meandering strip has opposite first and second ends. The first end of the meandering strip is connected to the shorting element. The flat plate has a connecting side that is connected to the second end of the meandering strip, and that has a length different from that of the second end of the meandering strip. The feeding element has a first end that is coupled to the radiating element, and a second end that extends through and that is free from electrical contact with the ground element.

### BRIEF DESCRIPTION OF THE DRAWINGS

Other features and advantages of the present invention will become apparent in the following detailed description of the preferred embodiments with reference to the accompanying drawings, of which:

FIG. 1 is a perspective view of the conventional planar inverted-F antenna.

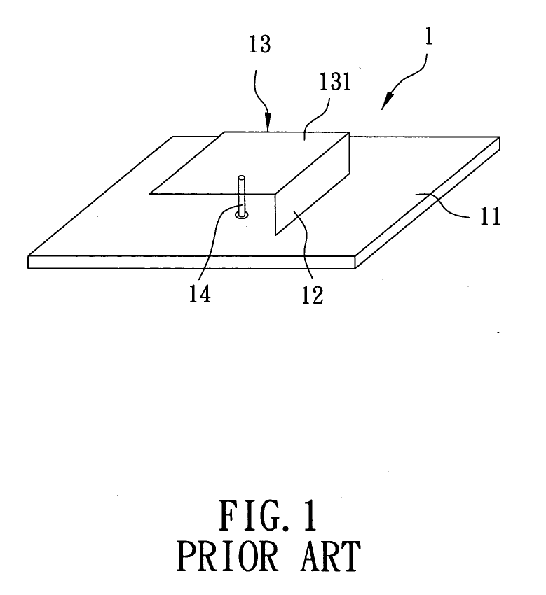

FIG. 2 is a perspective view of the first preferred embodiment of a planar inverted-F antenna according to the present invention;

FIG. 3 is a graph illustrating simulated return loss of the first preferred embodiment

FIG. 4 is a graph illustrating an actual return loss of the first preferred embodiment;

FIG. 5 is a graph illustrating a simulated radiation pattern of the first preferred embodiment in an x-y plane;

FIG. 6 is a graph illustrating a simulated radiation pattern of the first preferred embodiment in an x-z plane; and

FIG. 7 is a perspective view of the second preferred embodiment of a planar inverted-F antenna according to the present invention.

### DETAILED DESCRIPTION OF THE PREFERRED EMBODIMENTS

Before the present invention is described in greater detail, it should be noted that like elements are denoted by the same reference numerals throughout the disclosure.

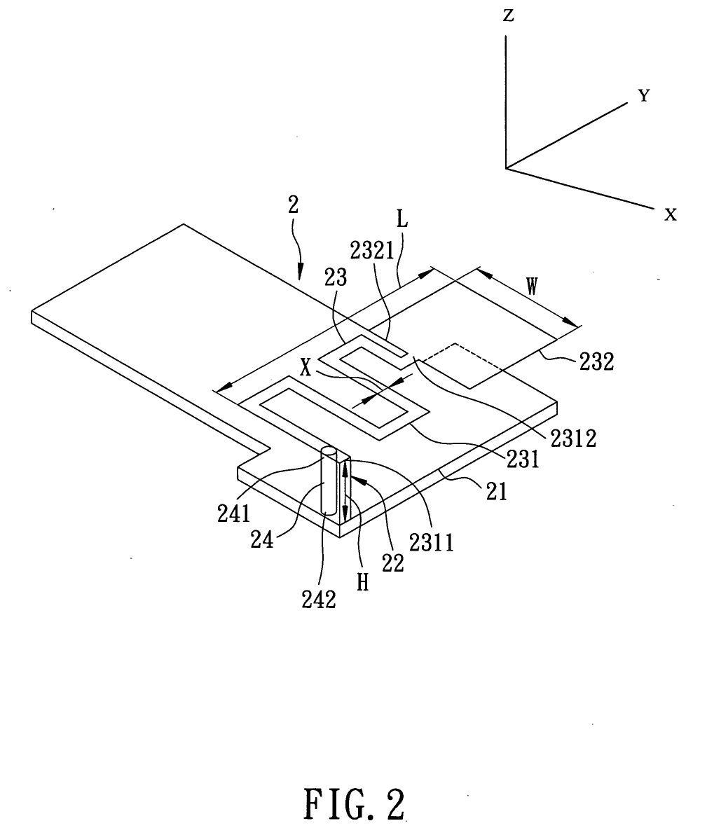

Referring to FIG. 2, the preferred embodiment of a planar inverted-F antenna 2 according to this invention is shown to include a conductive ground element 21, a conductive shorting element 22, a conductive radiating element 23, and a feeding element 24.

The planar inverted-F antenna 2 of this embodiment is adapted for used in a Bluetooth device (not shown). The Bluetooth device has a space of 5 mm×14 mm×2.5 mm available for an internal antenna. Therefore, the planar inverted-F antenna 2 of this invention is required to have overall dimensions such that it can be embedded within the given space, and at the same time, cover the Bluetooth bandwidth requirement of 2402 MHz to 2480 MHz centered around an operating frequency.

In this embodiment, the ground element 21 is made from metal, such as gold. Alternatively, the ground element 21 may be made from copper or other conductive materials.

The shorting element 22 extends upwardly from the ground element 21. In this embodiment, the shorting element 22 is made from metal, such as gold, copper, or other conductive materials.

The radiating element 23 is disposed above the ground element 21, extends transversely from the shorting element 22, and includes a meandering strip 231 and a first flat plate 232. In this embodiment, the radiating element 23 is made from metal, such as gold, copper, or other conductive materials.

It is noted that increasing the distance of the radiating element 23 above the ground element 21 will increase the operating bandwidth of the planar inverted-F antenna 2 of this invention. Thus, given the required operating bandwidth, the shorting element 22 is adjusted accordingly. In this embodiment, the shorting element 22 has a height (H) of 2.5 millimeters with respect to the ground element 21.

The meandering strip 231 has a first end 2311 connected to the shorting element 22, and a second end 2312 opposite to the first end 2311 of the meandering strip 231. The meandering strip 231 includes bends, each of which defines a right angle. In this embodiment, the meandering strip 231 includes six bends, and has a uniform width (X). It is noted that the shorting element 22 has a width that is preferably equal to that of the meandering strip 231.

The first flat plate 232 is substantially rectangular, and has a connecting side 2321 that is connected to the second end 2312 of the meandering strip 231 and that has a length different from that of the second end 2312 of the meandering strip 231. In this embodiment, the length of the connecting side 2321 of the first flat plate 232 is greater than that of the second end 2312 of the meandering strip 231. As shown in FIG. 2, the meandering strip 231 has an end portion that defines the second end 2312 of the meandering strip 231 and that is perpendicular to the connecting side 2321 of the first flat plate 232. It is noted that the difference in length between the second end 2312 of the meandering strip 231 and the connecting side 2321 of the first flat plate 232 results in a discontinuity in electrical property, which produces an inductance that alters electric field distribution across the radiating element 23. It is further noted that each of the meandering strip 231 and the first flat plate 232 has distinct characteristic impedance.

The feeding element 24 has opposite first and second ends 241, 242. The first end 241 of the feeding element 24 is coupled to the meandering strip 231 of the radiating element 23. The second end 242 of the feeding element 24 extends through and is free from electrical contact with the ground element 21, and is coupled to a transceiver (not shown). In this embodiment, the feeding element 24 has an input impedance of 50 Ohms.

It is noted that the operating frequency of the radiating element 23 is directly proportional to the ratio of the length of the second end 2312 of the meandering strip 231 to the length of the connecting side 2321 of the first flat plate 232. It is also noted that the meandering strip 231 has the effect of increasing electrical path without increasing the physical size of the same. Thus, given an operating frequency, the relative ratio of the length of the second end 2312 of the meandering strip 231 to the length of the connecting side 2321 of the first flat plate 232, and the effective length of the meandering strip are adjusted accordingly. Once adjusted, a suitable length (L) and width (W) of the radiating element 23 can be determined. In this embodiment, since the Bluetooth device reserves a 5 mm×14 mm×2.5 mm space for an internal antenna, the radiating element 23 has a length (L) of 14 millimeters and a width (W) of 5 millimeters.

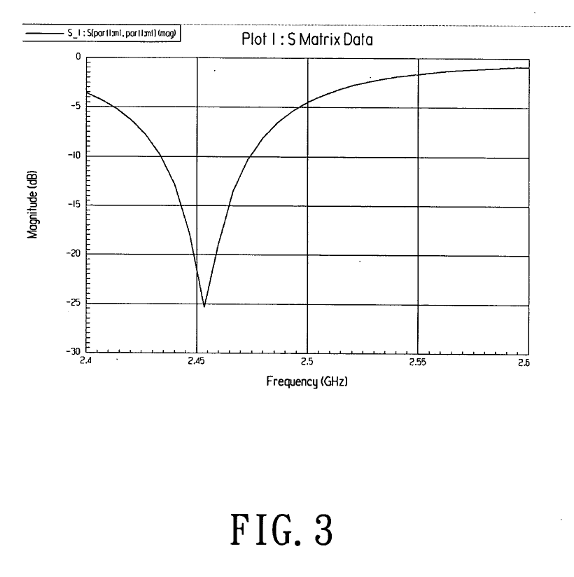

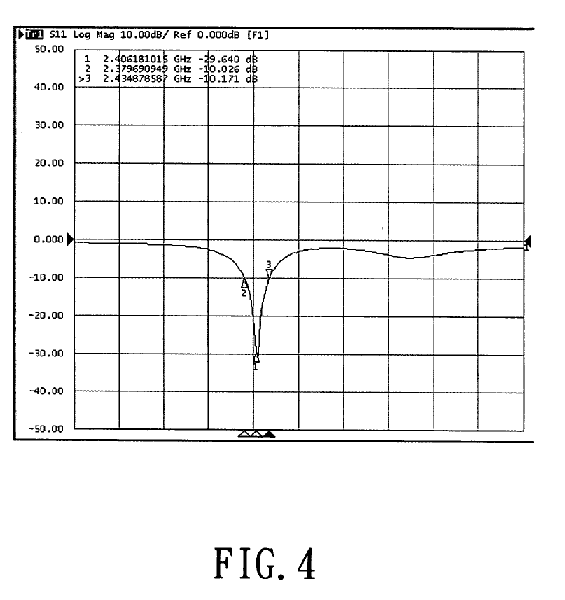

FIGS. 3 and 4 show the simulated and actual return losses of the planar inverted-F antenna 2 of this invention, respectively. Indeed, the planar inverted-F antenna 2 of this invention has its operating frequency centered within the 2402 MHz and 2480 MHz bandwidth in compliance with the Bluetooth bandwidth requirement.

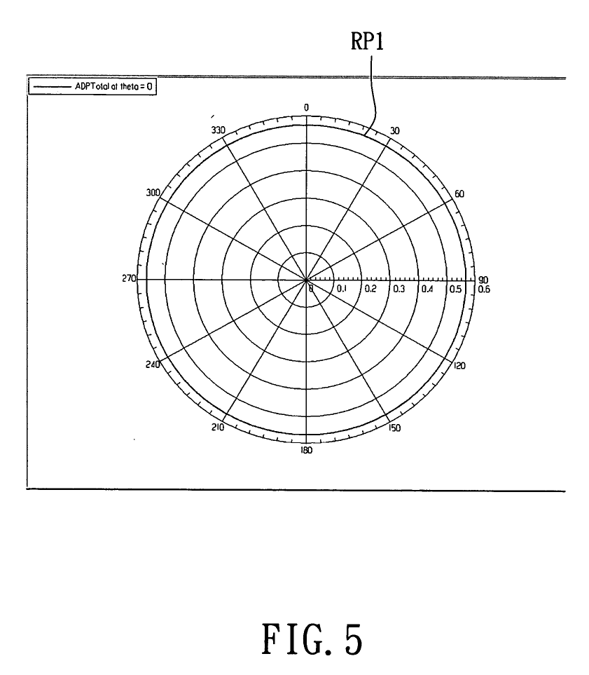

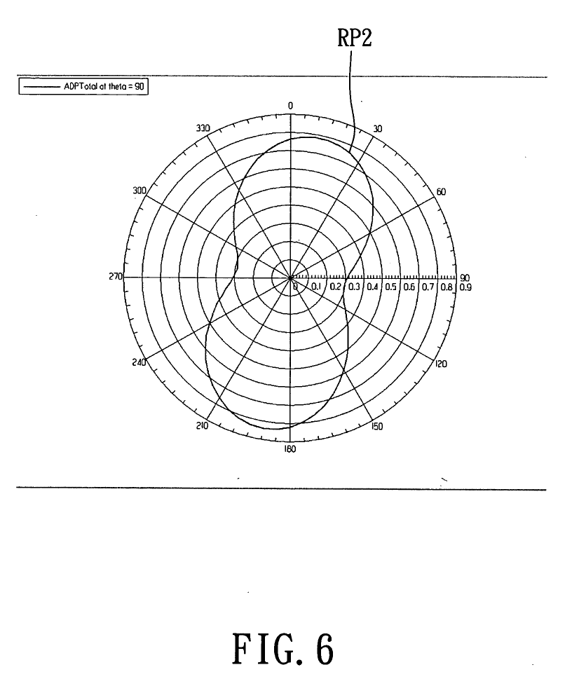

FIG. 5 shows a simulated radiation pattern (RP1) of the planar inverted-F antenna 2 of this invention in an x-y plane parallel to the conductive radiating element 23 (see FIG. 2). Moreover, FIG. 6 shows a simulated radiation pattern (RP2) of the planar inverted-F antenna 2 of this invention in an x-z plane transverse to the x-y plane (see FIG. 2). Indeed, the planar inverted-F antenna 2 of this invention has a satisfactory directivity.

From the above description, the planar inverted-F antenna 2 of this invention can be operated in different operating frequencies by adjusting both the ratio of the length of the second end 2312 of the meandering strip 231 to the length of the connecting side 2321 of the first flat plate 232, and the length of the meandering strip 231. Therefore, the overall area occupied by the planar inverted-F antenna 2 of this invention may be reduced as required.

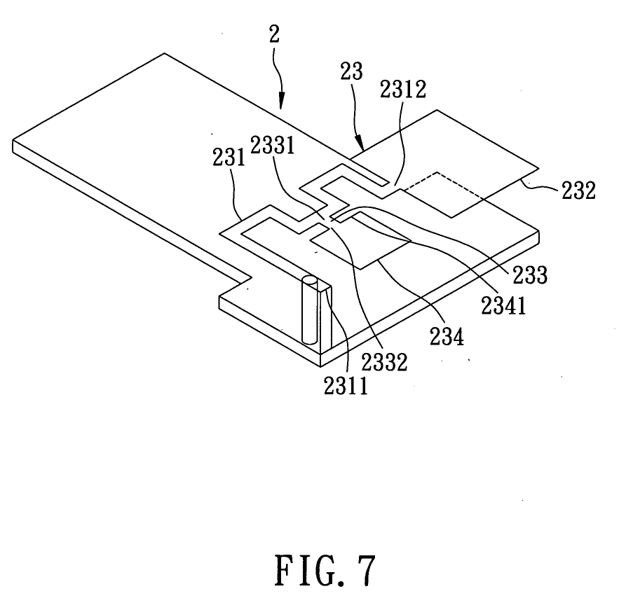

FIG. 7 illustrates the second preferred embodiment of a planar inverted-F antenna 2 according to this invention. When compared to the previous embodiment, the radiating element 23 further includes a connecting piece 233 and a second flat plate 234.

The connecting piece 233 extends from the meandering strip 231 at a position between the first and second ends 2311, 2312 of the meandering strip 231, and has a first end 2331 connected to the meandering strip 231, and a second end 2332 opposite to the first end 2331 of the connecting piece 233.

The second flat plate 234 extends from the connecting piece 233, and has a connecting side 2341 that is connected to the second end 2332 of the connecting piece 233, and that has a length different from that of the second end 2332 of the connecting piece 233. In this embodiment, the length of the connecting side 2341 of the second flat plate 234 is greater than that of the second end 2332 of the connecting piece 233. As shown in FIG. 6, the connecting piece 233 is perpendicular to the connecting side 2341 of the second flat plate 234.

As in the previous embodiment, the ratio of the length of the second end 2332 of the connecting piece 233 to the length of the connecting side 2341 of the second flat plate 234 can be adjusted so as to operate the radiating element 23 at a desired resonance frequency.

While the present invention has been described in connection with what is considered the most practical and preferred embodiments, it is understood that this invention is not limited to the disclosed embodiment but is intended to cover various arrangements included within the spirit and scope of the broadest interpretation so as to encompass all such modifications and equivalent arrangements.

What is claimed is:

1. A planar inverted-F antenna comprising:
a conductive ground element;
a conductive shorting element extending upwardly from said ground element;
a conductive radiating element disposed above said ground element, and extending transversely from said shorting element, said radiating element including
a meandering strip that has opposite first and second ends, said first end of said meandering strip being connected to said shorting element, and
a first flat plate that has a connecting side which is connected to said second end of said meandering strip, and having a length different from that of said second end of said meandering strip; and
a feeding element having a first end that is coupled to said radiating element, and a second end that extends through and that is free from electrical contact with said ground element.

2. The planar inverted-F antenna as claimed in claim 1, wherein said meandering strip includes bends, each of which defines a generally right angle.

3. The planar inverted-F antenna as claimed in claim 1, wherein said shorting element has a width that is substantially equal to that of said meandering strip.

4. The planar inverted-F antenna as claimed in claim 1, wherein said radiating element further includes
a connecting piece that extends from said meandering strip at a position between the first and second ends of said meandering strip, and that has a first end connected to said meandering strip, and a second end opposite to said first end of said connecting piece, and
a second flat plate that extends from said connecting piece, said second flat plate having a connecting side that is connected to said second end of said connecting piece, and that has a length different from that of said second end of said connecting piece.
